(19) United States
(12) Patent Application Publication
(10) Pub. No.: US 2022/0333019 A1
(43) Pub. Date: Oct. 20, 2022

(54) SYSTEM AND METHOD FOR MAKING A KEROSENE FUEL PRODUCT

(71) Applicant: ClearRefining Technologies, LLC, Kingston, WA (US)

(72) Inventors: Peter Wilhelm Gunnerman, Reno, NV (US); Ernst Josef Michael Rocholl, Auckland (NZ); Michael Brian Mabarak, Matthews, NC (US)

(21) Appl. No.: 17/855,659

(22) Filed: Jun. 30, 2022

Related U.S. Application Data
(63) Continuation of application No. PCT/US2020/067373, filed on Dec. 29, 2020.
(60) Provisional application No. 62/956,435, filed on Jan. 2, 2020.

(51) Int. Cl. C10G 11/20; C10G 15/08; B01J 10/00

(52) U.S. Cl. CPC C10G 11/20; C10G 15/08; B01J 10/002; C10G 2300/1055; C10G 2400/08

(57) ABSTRACT

A method for converting an ultra low sulfur diesel fuel to a kerosene product includes receiving an ultra low sulfur diesel fuel within a reaction vessel, delivering a gas through one or more spargers positioned within a reaction vessel into the ultra low sulfur diesel fuel so as to form aerosol droplets, passing the aerosol droplets through one or more catalyst grids positioned within the reaction vessel at a level above the ultra low sulfur diesel fuel at a speed between 0.01 m/s and 0.7 m/s, collecting a product gas resulting from the passing of the aerosol droplets through the catalyst grids, and condensing the product gas to form a kerosene product.

### INCORPORATION BY REFERENCE TO RELATED APPLICATIONS

Any and all priority claims identified in the Application Data Sheet, or any correction thereto, are hereby incorporated by reference under 37 CFR 1.57. This application is a continuation of PCT International Application No. PCT/US2020/067373, filed Dec. 29, 2020, which claims benefit of U.S. Provisional Application No. 62/956435, filed Jan. 2, 2020. Each of the aforementioned applications is incorporated by reference herein in its entirety, and each is hereby expressly made a part of this specification.

### BACKGROUND

### Field

The present disclosure relates generally to crude oil, crude oil transport, fuel refinement, and liquid fuels derived from crude oil.

### Description of the Related Art

Crude oil is the largest and most widely used source of power in the world. The fuels derived from crude oil enjoy a wide range of utility ranging from consumer uses such as fuels for automotive engines and home heating to commercial and industrial uses such as fuels for boilers, furnaces, smelting units, and power plants. Crude oil is a mixture of hydrocarbons differing widely in molecular weight, boiling and melting points, reactivity, and ease of processing. The mixture includes both light components that are of immediate utility and heavy components that have little or no utility, as well as components such as sulfur that are detrimental to the environment when carried over into the refined products. Many industrial processes have been developed to upgrade crude oil by removing, diluting, or converting the heavier components or those that tend to polymerize or otherwise solidify, notably the olefins, aromatics, and fused-ring compounds such as naphthalenes, indanes and indenes, anthracenes, and phenanthracenes.

### SUMMARY

Aspects of the present application include systems, devices, and methods for converting an ultra low sulfur diesel fuel to a kerosene product.

One aspect is a method for converting an ultra low sulfur diesel fuel to a kerosene product is provided. The method includes receiving an ultra low sulfur diesel fuel within a reaction vessel, delivering a gas through one or more spargers positioned within a reaction vessel into the ultra low sulfur diesel fuel so as to form aerosol droplets, passing the aerosol droplets through one or more catalyst grids positioned within the reaction vessel at a level above the ultra low sulfur diesel fuel at a speed between 0.01 m/s and 0.7 m/s, collecting a product gas resulting from the passing of the aerosol droplets through the catalyst grid, and condensing the product gas to form a kerosene product.

In some embodiments, the aerosol droplets can pass through the one or more catalyst grids at a speed between 0.05 m/s and 0.65 m/s. In some embodiments, the aerosol droplets can pass through the one or more catalyst grids at a speed between 0.1 m/s and 0.6 m/s. In some embodiments, the aerosol droplets can pass through the one or more catalyst grids at a speed between 0.2 m/s and 0.5 m/s. In some embodiments, the reaction vessel can include a cylindrical reaction vessel having an inner height between 55 inches and 65 inches and an inner diameter between 22.5 inches and 32.5 inches. In some embodiments, the method can further include introducing ultra low sulfur diesel fuel into the reaction vessel so that the liquid level in the reaction vessel is between 2 inches and 16 inches. In some embodiments, introducing ultra low sulfur diesel fuel into the reaction vessel includes introducing ultra low sulfur diesel fuel into the reaction vessel so that the liquid level in the reaction vessel is between 4 inches and 14 inches. In some embodiments, introducing ultra low sulfur diesel fuel into the reaction vessel includes introducing ultra low sulfur diesel fuel into the reaction vessel so that the liquid level in the reaction vessel is between 6 inches and 12 inches. In some embodiments, the height of the reaction vessel is 59.75 inches and the inner diameter of the reaction vessel is 27.5 inches. In some embodiments, delivering a gas through the one or more spargers includes operating a pump at a pump speed between 30% and 60% of a maximum pump output to pump gas through the spargers.

Another aspect is a system for converting an ultra low sulfur diesel fuel to a kerosene product. The system includes a reaction vessel configured to house an ultra low sulfur diesel fuel, one or more catalyst grids configured to be positioned above the ultra low sulfur diesel fuel within the reaction vessel, and one or more spargers positioned below the one or more catalyst grids within the reaction vessel and configured to introduce gas into the ultra low sulfur diesel fuel within the reaction vessel so as to form aerosol droplets that pass through the one or more catalyst grids at a speed between 0.01 m/s and 0.7 m/s.

In some embodiments, the one or more spargers are configured to introduce gas within the ultra low sulfur diesel fuel so that the aerosol droplets pass through the one or more catalyst grids at a speed between 0.05 m/s and 0.65 m/s. In some embodiments, the one or more spargers are configured to introduce gas within the ultra low sulfur diesel fuel so that the aerosol droplets pass through the one or more catalyst grids at a speed between 0.1 m/s and 0.6 m/s. In some embodiments, the one or more spargers are configured to introduce gas within the ultra low sulfur diesel fuel so that the aerosol droplets pass through the one or more catalyst grids at a speed between 0.2 m/s and 0.5 m/s. In some embodiments, the reaction vessel includes a cylindrical reaction vessel having an inner height between 55 inches and 65 inches and an inner diameter between 22.5 inches and 32.5 inches. In some embodiments, the reaction vessel is configured to house the ultra low sulfur diesel fuel at a liquid level between 2 inches and 16 inches. In some embodiments, the reaction vessel is configured to house the ultra low sulfur diesel fuel at a liquid level between 4 inches and 14 inches. In some embodiments, the reaction vessel is configured to house the ultra low sulfur diesel fuel at a liquid level between 6 inches and 12 inches. In some embodiments, the height of the reaction vessel is 59.75 inches and the inner diameter of the reaction vessel is 27.5 inches. In some embodiments, the system further includes a pump configured to deliver a gas through the one or more spargers. In some embodiments, the system further includes a condenser configured to condense a product gas resulting from the passing of the aerosol droplets through the catalyst grids to form a kerosene product.

### BRIEF DESCRIPTION OF THE DRAWINGS

FIG. 1 is a process flow diagram embodying one example of an implementation of a system for producing a liquid fuel product.

FIG. 2 is a process flow diagram embodying a second example of an implementation of a system for producing a liquid fuel product.

FIG. 3 is a top view of a catalyst grid used in the reactors shown in the process flow diagrams of FIGS. 1 and 2.

FIG. 4 is a process flow diagram embodying a third example of an implementation of a system for producing a liquid fuel product.

### DETAILED DESCRIPTION

One aspect described herein relates to methane, and gas mixtures containing methane, being utilized in the modification of a liquid feedstock consisting of crude oil or a liquid petroleum fraction to achieve a liquid fuel product having different characteristics and/or properties in comparison to the liquid feedstock. For example, in some embodiments, methane, and gas mixtures containing methane, can be utilized in the modification of a liquid feedstock comprising a crude oil or a liquid petroleum fraction to achieve a hydrocarbon mixture with a substantially greater proportion of low-boiling components than that of the liquid feedstock. This transformation is achieved by passing the methane at moderate temperature and pressure through a reactor that contains both the liquid feedstock and a solid metallic catalyst, drawing a gaseous product from the reactor, and condensing the gaseous product to liquid form. In certain embodiments, an electric potential is spontaneously generated in the reactor, without being initiated or supplemented by an externally imposed potential. The electric potential can be detected between sites on the metallic grid. Notably, for a grid that consists of windings of a conductive metal or combination of conductive metals, such as two or more transition metals and preferably also aluminum, over an iron frame, the electric potential can be measured between the windings and the iron frame. The fluctuations of the potential are generally irregular in both amplitude and frequency, but with a time-averaged value that significantly exceeds, by at least a factor of ten, the value of any such potential that exists between the same sites on the catalyst grid in the absence of the gas flow through the grid. In some embodiments, the catalyst grid can be immersed within the liquid feedstock. In other embodiments, the catalyst grid can be positioned within the reactor separate from the liquid feedstock. For example, in some embodiments, the catalyst grid can be placed above the liquid feedstock.

The liquid condensate produced by the reaction can be useful for a wide range of applications, including both fuels and additives. In some embodiments, the liquid condensate can be useful for further processing, either in a refinery or as a second-stage liquid medium for reaction with further methane, for example, in the presence of the same type of catalyst in the same reactor configuration, in place of the starting liquid feedstock. The product is thus derived from natural gas or other sources of methane with little or no need for disposal of gaseous by-products.

When the liquid feedstock is crude oil, hydrocarbon values are extracted from the heavy residual components of crude oil that are otherwise useful only for paving or roofing or other similar applications. Heavy crude oils can thus be converted to upgraded refinery feedstocks for more efficient fractionation, and automotive fuels can be obtained directly from the crude oil and methane, without fractionation of the crude oil. By their consumption of methane, the embodiments described herein can eliminate the need for disposal of petroleum gas at oil fields, or for the recovery of the gas at the fields and transportation of the recovered gas to remote destinations for consumption. One of the many uses of the hydrocarbon mixture resulting from the processes described herein is as a blending agent for the crude oil to lower the viscosity of the crude oil and thereby increase its mobility for pumping through a long distance pipeline. The low-viscosity blend is formed without the need for costly additives at the source, or for heating equipment at the source or in the pipeline, or for emulsion breaking and separation at the destination, and can be formed entirely from materials extracted from the oil field.

In certain embodiments, the liquid feedstock can be Ultra Low Sulfur Diesel (ULSD) fuel. It has been discovered that, using the processes described in certain embodiments herein, an ULSD fuel can be transformed to a kerosene product. In certain embodiments, a low sulfur kerosene product can be achieved. This transformation is achieved by passing the methane at moderate temperature and pressure through a reactor that contains both the ULSD fuel feedstock and a solid metallic catalyst, drawing a gaseous product from the reactor, and condensing the gaseous product to liquid form. In certain embodiments, an electric potential is spontaneously generated in the reactor, without being initiated or supplemented by an externally imposed potential.

The kerosene product produced by the above-described reaction can be useful for a wide range of applications, including both fuels and additives. For example, kerosene is often blended with standard diesel fuel to form winter diesel or #1 diesel. Traditionally, kerosene is transported to a user or terminal for blending. Certain embodiments described herein facilitate production of kerosene on site from readily available diesel for blending.

In certain embodiments, the kerosene product produced by the above-described reaction can be used as a low emission fuel alternative to diesel fuel. For example, in some embodiments, the kerosene product can used directly in a diesel engine as a low emission alternative.

In some embodiments, the kerosene product can be useful for further processing, either in a refinery or as a second-stage liquid medium for reaction with further methane, for example, in the presence of the same type of catalyst in the same reactor configuration, in place of the starting liquid feedstock. The product is thus derived from natural gas or other sources of methane with little or no need for disposal of gaseous by-products.

A low sulfur kerosene produced by the above-described reaction may have sulfur content that makes the lower sulfur kerosene product advantageous for use as a low emission jet fuel.

These and other features, objects, and advantages of the present embodiments will be apparent from the description that follows.

The crude oil used in certain embodiments of the present application can include any of the various grades of crude oil, with particular interest in heavy and extra heavy crude oils. As used herein, the term “heavy crude oil” refers to any liquid petroleum with an API gravity less than 20° , equivalent to a specific gravity greater than 0.934 and a density greater than 7.778 lb/US gal (932 kg/m³), and the term “extra heavy crude oil” refers to any liquid petroleum with an API gravity of 15° or less (specific gravity greater than 0.96 and a density greater than 8.044 lb/US gal or 964 kg/m³) and a viscosity of 1,000-10,000 centipoise and higher (up to 100,000 centipoise). Heavy crude oil is found in Alberta and Saskatchewan, Canada, and also in California, Mexico, Venezuela, Colombia, and Ecuador, as well as Central and East Africa. Extra heavy crude oil is found in Venezuela and Canada.

For embodiments using petroleum fractions, these fractions can include fossil fuels, crude oil fractions, and many of the components derived from these sources. Fossil fuels, as is known in the art, are carbonaceous liquids derived from petroleum, coal, and other naturally occurring materials, and also include process fuels such as gas oils and products of fluid catalytic cracking units, hydrocracking units, thermal cracking units, and cokers. Included among these carbonaceous liquids are automotive fuels such as gasoline, diesel fuel, jet fuel, and rocket fuel, as well as petroleum residuum-based fuel oils including bunker fuels and residual fuels. The term “diesel oil” denotes fractions or products in the diesel range, such as straight-run diesel fuel, feed-rack diesel fuel (diesel fuel that is commercially available to consumers at gasoline stations), light cycle oil, and blends of straight-run diesel and light cycle oil. The term “crude oil fractions” includes any of the various refinery products produced from crude oil, either by atmospheric distillation or by vacuum distillation, as well as fractions that have been treated by hydrocracking, catalytic cracking, thermal cracking, or coking, and those that have been desulfurized. Examples of crude oil fractions other than diesel oils are light straight-run naphtha, heavy straight-run naphtha, light steam-cracked naphtha, light thermally cracked naphtha, light catalytically cracked naphtha, heavy thermally cracked naphtha, reformed naphtha, alkylated naphtha, kerosene, hydrotreated kerosene, gasoline and light straight-run gasoline, atmospheric gas oil, light vacuum gas oil, heavy vacuum gas oil, residuum, vacuum residuum, light coker gasoline, coker distillate, FCC (fluid catalytic cracker) cycle oil, and FCC slurry oil. In some embodiments, liquids used as the reaction medium are mineral oil, diesel oil, naphtha, kerosene, gas oil, and gasoline. In some embodiments, liquids used as the reaction medium are diesel oil, kerosene, and gasoline. In some embodiments, liquids used as the reaction medium are kerosene and diesel oil.

In the production of refinery products from crude oil, such as kerosene, a separation process, such as distillation, can be used to separate crude oil into fractions. The separated fractions can then be further processed, for example via catalytic reforming, alkylation, catalytic cracking, and/or hydroprocessing to purify a corresponding crude oil fraction into a desired product, such as kerosene. Additional processing may also be performed to remove contaminants and impurities. Among other uses, kerosene can be used as a fuel, for example, in heating and lighting, cooking, and in engines, and as a solvent. The sulfur content of kerosene can be dependent on the sulfur content of the crude oil used in the production process. For example, a crude oil having a higher sulfur content can result in kerosene having a higher sulfur content than a kerosene produced from a crude oil having a lower sulfur content.

The methane used in the practice of processes described herein can include both methane itself and gas mixtures containing methane, from any natural, municipal, agricultural, ecological, or industrial source. One example of a gas mixture containing methane is “coal bed methane,” otherwise known as “coal mine methane” and “abandoned mine methane.” Another example is petroleum gas, of which methane is the major component, the other components including ethane, propane, propylene, butane, isobutane, butylenes, and other C4+ light hydrocarbons. Hydrogen, carbon dioxide, hydrogen sulfide, and carbonyl sulfide are also present in certain cases. A further example is landfill gas, of which methane constitutes about 40-60%, with the remainder primarily carbon dioxide. A still further example is methane from industrial sources, examples of which are municipal waste treatment plants. Landfill gas is commonly derived by bacterial activity in the landfill, while gas from municipal waste treatment plants is derived by bacterial activity or by heating. In some embodiments, gases containing at least about 50% methane are utilized. In some embodiments, gases with 70% or more methane are utilized. In some embodiments, gases with at least 85% methane are utilized. In some embodiments, gases containing 90% to 100% methane are of particular interest. This includes natural gas, of which methane typically constitutes approximately 95 mole percent. In some embodiments, natural gas when used is preferably used without supplementation with other gases, and particularly without significant amounts of carbon monoxide, preferably less than 1% by volume of each. All percents in this paragraph are by volume unless otherwise stated.

In some embodiments, the catalyst used in the practice of systems and processes described herein is a transition metal catalyst, and can consist of a single transition metal or combination of transition metals, either as metal salts, pure metals, or metal alloys. In some embodiments, catalysts for use in the systems and processes described herein are metals and metal alloys. In some embodiments, transition metals having atomic numbers ranging from 23 to 79 are utilized. In some embodiments, transition metals with atomic numbers ranging from 24 to 74 are utilized. In some embodiments, cobalt, nickel, tungsten, iron, and chromium, are utilized. In some embodiments, the catalyst can include cobalt, nickel, tungsten, iron, and chromium in combination. The transition metal can also be used in combination with metals other than transition metals. An example of such an additional metal is aluminum.

In some embodiments, the catalyst is used in solid form and can either be immersed in the crude oil or liquid petroleum fraction, such as ULSD fuel, positioned in the head space above the crude oil or liquid petroleum fraction, such as ULSD fuel, or both. In either case, the methane-containing gas can be bubbled through the oil or liquid petroleum fraction and through or past the catalyst in a continuous-flow reaction. The catalyst can assume any form that allows intimate contact with both the methane and the crude oil or liquid petroleum fraction and allows free flow of gas over and past the catalyst. Non-limiting examples of suitable forms of the catalyst are pellets, granules, wires, mesh screens, perforated plates or grids, rods, and strips. Granules and wires suspended across plates or between mesh matrices such as steel or iron wool are can be used for their relatively accessible high surface area. When granules are used, the granules can be maintained in a fluidized state in the reaction medium or held stationary in the form of a fixed bed. In certain embodiments, the catalyst is a metallic grid, which term is used herein to denote any fixed form of metallic catalyst that is contains interstices or pores that allow gas to pass through the grid. The term thus encompasses packed beds, screens, open-weave wire networks, and any other forms described above. The metal can be in bare form or supported on inert supports as coatings or laminae over ceramic substrates. A single catalyst grid spanning the width of the reactor can be used, or two or more such grids can be arranged in a vertical stack within the reactor, optionally with a small gap between adjacent grids. When two or more catalyst grids are used, at least one grid preferably resides in the head space above the liquid level. In some cases, the entire stack of grids resides in the head space, although the lowermost grid may be in intermittent contact with the liquid as the bubbling of the methane-containing gas through the liquid causes splashing of the liquid during the reaction.

When the catalyst is in the form of wires, individual cobalt, nickel, aluminum, chromium, and tungsten wires, for example, of approximately equal diameter and length, can be strung across a frame of cast iron, pig iron, gray iron, or ductile iron to form an open-mesh network which can then be supported inside the reactor. The wires can be supported on the frame directly or by being wound around pegs affixed to the frame, where the pegs are formed of a material that has an electrical resistivity that is substantially higher than the electrical resistivities of both the windings and of the frame. When pegs are used, in some embodiments, the pegs can have an electrical resistivity of at least about 15×10⁻⁸ ohm meters at 100° C. Chromium and chromium alloys are examples of materials that meet this description. A reactor can contain a single frame strung with wires in this manner or two or more such frames, depending on the size of the reactor. In a still further variation, the catalyst wire can be wound as a coil or other wrapping around or over piping that serves as a gas distributor for incoming gas.

In some embodiments, when wires of the metal catalyst are used, the wires are wound on the frame in such a manner that an electric potential is produced between the wires and the iron frame when the reaction is running. The potential will vary with the distance between the site on the windings and the site on the frame between which the potential is measured, and in some cases, with the locations of the sites themselves. In general, the greater the distance, the larger the potential. When the frame is circular in outer diameter with reinforcing bars or rods within the perimeter and the windings converge at the center of the frame, the electric potential is most effectively measured between the windings at the center and a location on the frame itself that is radially displaced from the center, for example a distance equal to approximately half the radius of the frame. In certain embodiments, with gas feed rates to the reactor of 50 standard cubic feet per hour (SCFH) or greater, the electric potential between these points will be at least about 100 mV. In some embodiments, the electrical potential between these points will be from about 100 mV to about 10V. In some embodiments, the electrical potential between these points will have a time-averaged value of from about 300 mV to about 3V. In some embodiments, the electrical potential between these points will have mean fluctuation frequencies of from about 30Hz to about 300Hz. In certain embodiments, with gas feed rates within the range of about 10,000 cubic feet per hour to about 100,000 SCFH, the time-averaged electric potential between these points can be from about 100 mV to about 200 mV, the maximum values can be from about 1 V to about 5V, and the frequency can be from about 50 sec⁻¹ to about 1.000 sec⁻¹. In certain embodiments, the electrical potential, period, voltage, frequency, rise time, and/or fall time can affect the product produced using the processes described herein. In certain embodiments, the measured frequency is indicative of the amount of reaction occurring across the catalyst grids, such as, for example, a charge/discharge reaction caused by the electric potential of an aerosol formed using the systems and methods described herein. In certain embodiments, the frequency can affect the viscosity of the product and/or the flashpoint of the product. In certain embodiments, the voltage can affect of the viscosity of the product and/or the flashpoint of the product.

In certain embodiments, the methane-containing gas is supplied to the reactor through one or more gas distributors to convert the gas stream to small bubbles for release into the reaction vessel below the liquid level. For a reactor of circular cross section, the distributors may have a wheel-and-spokes configuration or any other shape that includes a network of hollow pipes with an array of apertures. In certain embodiments, to further enhance the distribution, these pipes, or at least the apertures, can be covered with a steel mesh or steel wool in combination with wires of the various metals listed above, to intercept the gas bubbles and reduce them further in size before they enter the reaction medium.

In certain embodiments, the reaction is performed under non-boiling conditions to maintain the liquid feedstock in a liquid state and to prevent or at least minimize the vaporization of components from the liquid feedstock and their escape in unreacted form from the reaction vessel with the product. An elevated temperature, i.e., a temperature above ambient temperature, is used, for example, one that is about 80° C. or above, more within the range of about 100° C. to about 250° C., within the range of about 150° C. to about 200° C., or any other suitable range. The operating pressure can vary as well, and can be either atmospheric, below atmospheric, or above atmospheric. In certain embodiments, the processes described herein are readily and most conveniently performed at either atmospheric pressure or a pressure moderately above atmospheric pressure. In some embodiments, operating pressures are within the range of about 1 atmosphere to about 2 atmospheres, within the range of about 1 atmosphere to about 1.5 atmospheres, or within any other suitable range.

In some embodiments, the flow rate of introduction of gas into the reactor can vary. In some embodiments, the flow rate of the introduction of gas is not critical. In some cases, best results in terms of product quality of economic operation will be obtained with a gas introduction rate of from about 60 to about 500 SCFH per U.S. gallon of crude oil or liquid petroleum fraction (approximately 106 to 893 liter/min of gas per liter of the oil or liquid petroleum fraction). In some embodiments, best results in terms of product quality of economic operation will be obtained with a gas introduction rate of from about 100 to about 300 SCFH per U.S. gallon of crude oil in the reactor (178 to 535 liter/min of gas per liter of the oil). However, other introduction rates may be beneficial in other embodiments. The reaction will cause depletion of the crude oil or liquid petroleum fraction volume at a slow rate, which can be corrected by replenishment with fresh crude oil or liquid petroleum fraction to maintain a substantially constant volume of liquid in the reactor. In some embodiments, the replenishment rate needed to accomplish this is readily determined by simple observation of the liquid level in the tank, and in most cases will range from about 0.5 to about 4.0 parts by volume per hour per 10 parts by volume initially charged to the reactor for continuous, steady-state operation. In certain embodiments, the volumetric production of condensed liquid product per volume of crude oil or liquid petroleum fraction consumed ranges from about 0.5 to about 5.0, or from about 1.0 to about 3.0, and test data currently available upon the date of application for this patent indicates a value of approximately 2.0 for this ratio.

In some embodiments, the gaseous product emerging from the reactor is condensed to a liquid whose distillation curve differs from that of the liquid feedstock by being shifted downward. In certain embodiments, when the liquid feedstock is crude oil or petroleum, the condensed product has a distillation curve that is shifted downward relative to petroleum by about 100 degrees Celsius or more. In certain embodiments, the condensed product can be used directly as a fuel, a refinery feedstock, a blending agent for pipeline transport, or any of various other uses outside the plant. Alternatively, the condensed product can be used as the liquid phase in a second-stage reaction with a gaseous reactant from the same source as the first reactant, the same or similar catalyst, and the same or similar reaction conditions, to produce a secondary condensate of a still higher grade. The secondary condensate will have more enhanced properties, making it even more suitable for each of the various end uses set forth above.

In certain embodiments, the systems and processes described herein can be used to achieve a kerosene product from a diesel fuel reaction medium. In certain embodiments, the systems and processes described herein can be used to achieve a low sulfur kerosene product from a ULSD reaction medium. For example, as illustrated in Tables VI to IX, kerosene having a sulfur content of 0.0030 weight % or less may be produced using the systems and processes described herein.

In certain embodiments, the production of low sulfur kerosene product from a ULSD reaction medium can depend on a liquid level in the reaction vessel. In some embodiments, the production of low sulfur kerosene product from a ULSD reaction medium can depend on a percentage of the internal volume of the reaction vessel occupied by liquid (feed fuel and/or heel).

In some embodiments, an aerosol can be produced by passing a gas, such as methane, through the liquid within the reaction vessel. In some embodiments, gas, such as methane, can be introduce into the reaction vessel by a pump. For example, in some embodiments, gas is delivered to the reaction vessel by one or more spargers, forming gas bubbles that are passed through the liquid. Passing gas bubbles through the liquid in the reaction vessel can result in the formation of aerosol (gas/petroleum mixture) droplets. In some embodiments, aerosol droplets can pass through catalyst grids in the reaction vessel.

In certain embodiments, the production of low sulfur kerosene product from a ULSD reaction medium can depend on a speed of the aerosol droplets as the aerosol droplets pass through the catalyst grids in the reaction vessel. In certain embodiments, the production of low sulfur kerosene product from a ULSD reaction medium can be achieved when the aerosol droplets have a speed between 0.01 m/s and 0.7 m/s, between 0.05 m/s and 0.65 m/s. between 0.1 m/s and 0.6 m/s, between 0.2 m/s and 0.5 m/s, or any other suitable range.

In certain embodiments, the speed at which the aerosol droplets pass through the catalyst grid can depend on one the liquid level in the reaction vessel and/or the percentage of the internal volume of the reaction vessel occupied by liquid. In certain embodiments, the production of low sulfur kerosene product from a ULSD reaction medium can be achieved with a liquid level between 2 inches to 16 inches, between 4 inches to 14 inches, between 6 inches and 12 inches, or any other suitable range in a cylindrical reaction vessel having an inner height of 59.75 inches and an inner diameter of 27.5 inches.

In certain embodiments, the speed at which the aerosol droplets pass through the catalyst grid can depend on the speed at which the gas bubbles pass through the liquid in the reaction vessel. In certain embodiments, the speed at which the gas bubbles pass through the liquid in the reaction vessel depends on a speed of the pump feeding gas into the reaction vessel. In certain embodiments, the production of low sulfur kerosene product from a ULSD reaction medium can depend on an amount of aerosol formed. In certain embodiments, the amount of aerosol formed can depend on the speed of the pump.

In some embodiments, the production of low sulfur kerosene product from a ULSD reaction medium can depend on a percentage of a maximum pump speed output. In certain embodiments, the production of low sulfur kerosene product from a ULSD reaction medium can be achieved with a pump speed between 30% to 60% of the maximum pump output.

In some embodiments, a relatively higher aerosol speed can cause increased friction of aerosol droplets crossing the catalyst grids, which can result in increased electric discharge in the catalytic wires in comparison to a relatively lower aerosol speed.

In certain embodiments of processes described herein, a heel product (residual product left in the reaction vessel) can be produced in addition to the liquid fuel product. In certain embodiments, a heel product produced in a process for producing low sulfur kerosene product from a ULSD reaction medium may be produced at a greater rate than a heel in process in which a modified or improved diesel fuel is produced from a diesel fuel reaction medium. In such embodiments, it may be desirable to include a heat exchanger to allow for a more rapid reduction in temperature of the heel and evacuation of the heel from the reaction vessel.

In some embodiments, the heel may be collected and used, for example, as an additive. The heel may include some diesel qualities, but may also include high levels of cetane and enhanced lubricating qualities.

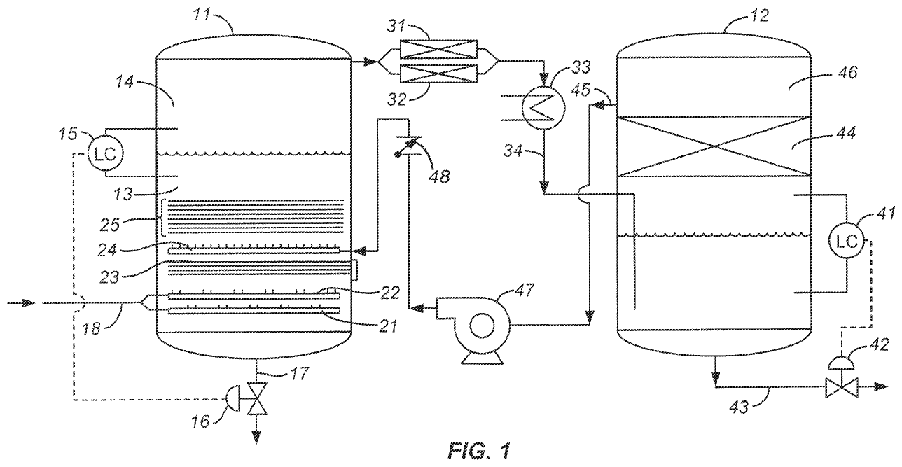

The Figures described herein present examples of process flow diagrams for implementation of the present embodiments in a production facility. The flow diagram in FIG. 1 includes a reaction vessel 11 and a product vessel 12, each of which is a closed cylindrical tank. The reaction vessel 11 is charged with any of the liquid feedstocks 13 described herein, the liquid feedstock occupying a portion of the internal volume of the vessel, leaving a gaseous head space 14 above the liquid level. The liquid level is maintained by a level control 15 which is actuated by a pair of float valves inside the vessel. The level control 15 governs a motor valve 16 on a drain line 17 at the base of the vessel.

Natural gas or other methane-containing gas is fed to the reaction vessel 11 underneath the liquid level at an inlet gas pressure of from about 3 psig to about 20 psig, through a gas inlet line 18 which is divided among two gas distributors 21, 22 inside the reaction vessel, each distributor spanning the full cross section of the vessel. The number of feed gas distributors can vary and can be greater or lesser than the two shown. A resistance heater 23 is positioned in the reactor above the gas distributors, and a third gas distributor 24 is positioned above the resistance heater. The third gas distributor 24 receives return gas from the product receiving vessel 12 as explained below.

Positioned above the three gas distributors 21, 22, 24 and the resistance heater 23 but still beneath the liquid level are a series of catalyst grids 25 arranged in a stack. Each grid is a circular frame with metallic catalyst wires strung across the frame. With wires that are 1 mm in diameter, for example, and with individual wires for each metal, two pounds of each metal wire can be used per frame, or eight pounds total per frame. In certain embodiments, seven frames are used, each wound with the same number and weight of wires. Screens of wire mesh are placed between adjacent plates or grids for further reduction of the sizes of the gas bubbles. Stainless steel or aluminum screens of 40-mesh (U.S. Sieve Series) can be used.

Product gas is drawn from the head space 14 of the reaction vessel 11 and passed through a supplementary catalyst bed of the same catalyst material as the catalyst grids 25 of the reaction vessel. In FIG. 1, two such supplementary catalyst beds 31, 32 of identical construction and catalyst composition are arranged in parallel. The supplementary catalyst beds in this embodiment are metallic wire screens, grids, or perforated plates or grids similar to those of the catalyst grids 25 in the reaction vessel 11. The supplementary catalyst promotes the same reaction that occurs in the reaction vessel 11 for any unreacted material that has been carried over with the product gas drawn from the reaction vessel. Product gas emerging from the supplementary catalyst beds is passed through a condenser 33, and the resulting condensate 34 is directed to the product vessel 12 where it is introduced under the liquid level in the product vessel.

The liquid level in the product vessel 12 is controlled by a level control 41 that is actuated by a pair of float valves inside the vessel and that governs a motor valve 42 on a liquid product outlet line 43 at the base of the vessel. Above the liquid level is a packed bed 44 of conventional tower packings. Examples are Raschig rings, Pall rings, and Intalox saddles; other examples will be readily apparent to those familiar with distillation towers and column packings. The packing material is inert to the reactants and products of the system, or at least substantially so, and serves to entrap liquid droplets that may be present in the gas phase and return the entrapped liquid back to the bulk liquid in the lower portion of the vessel. Unreacted gas 45 is withdrawn from the head space 46 above the packed bed by a gas pump 47. The pump outlet is passed through a check valve 48 and then directed to the reaction vessel 11 where it enters through the gas distributor 24 positioned between the resistance heater 23 and the catalyst grids 25.

In certain embodiments, the pump 47 can have a maximum output between 1500 rpm and 3000 rpm, between 1750 rpm and 2750 rpm, between 2000 rpm and 2500 rpm, or any other suitable range. In certain embodiments, the pump 47 can have a maximum output of 2230 rpm. In certain embodiments, the pump 47 can have a maximum output between 200 SCFM and 800 SCFM of methane circulation, between 300 SCFM and 700 SCFM of methane circulation, between 400 SCFM and 600 SCFM of methane circulation or any other suitable range. In certain embodiments, the pump 47 can have a maximum output of 500 SCFM of methane circulation. In certain embodiments, the pump is a vacuum pump. In certain embodiments, the pump is a Tuthill Vacuum Pump model 5507.

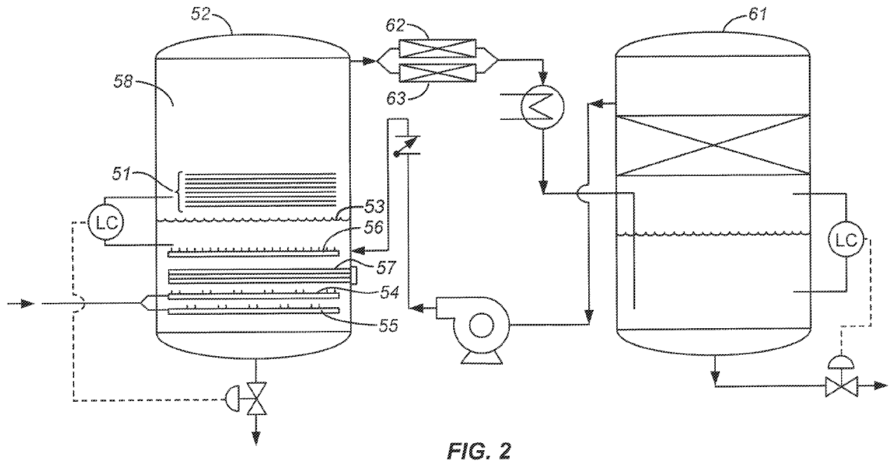

The production facility in FIG. 2 is identical to that of FIG. 1 except that the catalyst grids 51 are mounted at a height in the reaction vessel 52 that is above the liquid level 53.

Methane-containing gas is fed to the reaction vessel 52 underneath the liquid level as in FIG. 1, at the same pressure and through gas distributors 54, 55 similarly placed, and gas from the product receiving vessel 61 enters the reaction vessel 52 through a third gas distributor 56, also under the liquid level. A resistance heater 57 is positioned in the reaction vessel in the same location as the resistance heater of FIG. 1. As in FIG. 1, product gas is drawn from the head space 58 of the reaction vessel 52 above the catalyst grids 51. The remaining units in the flow diagram, including the product receiving vessel 61, the supplementary catalyst beds 62, 63, and their associated components, connecting lines, and valves, are identical to those of FIG. 1.

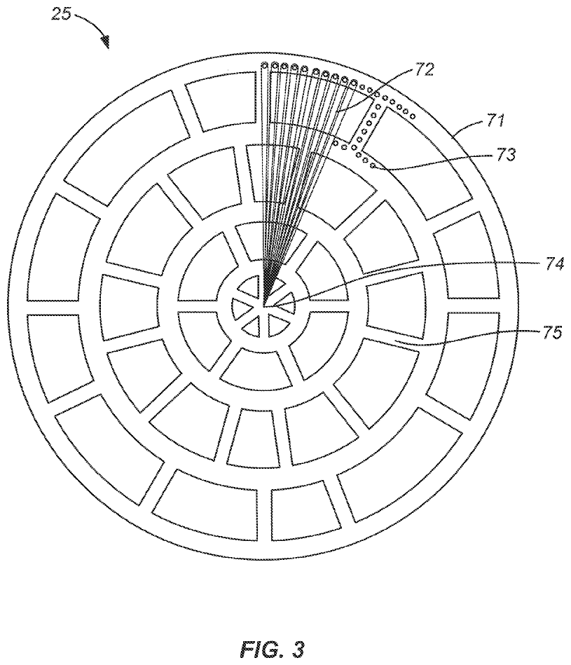

FIG. 3 is a top view of one of the catalyst grids 25 of FIG. 1, which can be similar to the catalyst grids 51 of FIG. 2 The view of FIG. 3 shows the frame 71 and only a portion of the windings 72 for convenience. In some embodiments, the windings continue to cover the full circumference of the frame. Also shown are pegs 73 around which the windings are wound. The electric potential discussed above can be measured between the collected windings at the center 74 of the grid and a site 75 on the frame at a distance approximately half the length of the radius from the center.

Alternatives to the units described above and shown in the figure will be readily apparent to the skilled chemical engineer. The resistance heater, for example, can be replaced by heating jackets, heating coils using steam or other heat-transfer fluids, or radiation heaters.

Heating of the reaction vessel can also be achieved by recirculation of heat transfer fluid between the coolant side of the condenser and the reaction vessel. The gas distributors for the inlet feed and the recycle gas can be perforated plates or grids, cap-type distributors, pipe distributors, or other constructions known in the art. Liquid level control can be achieved by float-actuated devices, devices measuring hydrostatic head, electrically actuated devices, thermally actuated devices, or sonic devices. The condenser can be a shell-and-tube condenser, either horizontal or vertical, or a plate-and-frame condenser, and either co-current or counter-current. The condensers can be air-cooled, water-cooled, or cooled by organic coolant media such as automotive anti-freeze or other glycol-based coolants.

In some embodiments, the examples of FIGS. 1 and 2 can include an additional heat exchanger to facilitate cooling of a heel product in the reaction vessel.

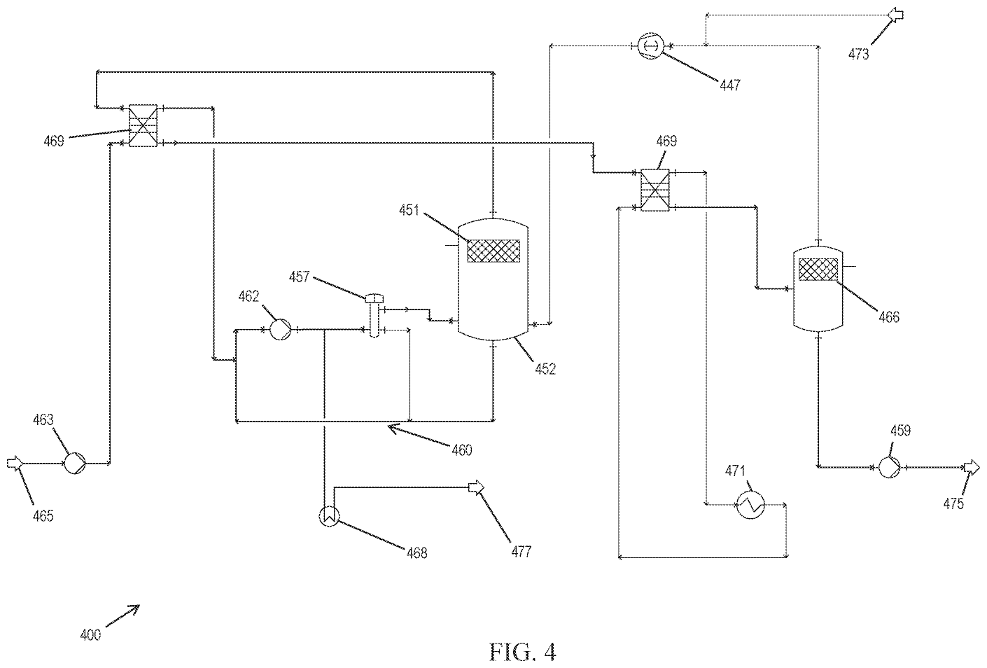

FIG. 4 depicts an embodiment of a production facility 400. The production facility 400 of FIG. 4 can include any of the same or similar features and functions as the production facilities described in FIGS. 1 and 2. Similar to the production facility of FIG. 2, but different than the production facility of FIG. 1, the catalyst grids 451 in the production facility 400 are positioned above the liquid level.

The production facility of FIG. 4 further differs from the production facilities of FIGS. 1 and 2 in that a fuel heater 457 is inline and external to the reaction vessel 452 in a fuel recirculation loop 460. In some embodiments, the production facility 400 may not include a resistance heater positioned within the reaction vessel as described with respect to FIGS. 1 and 2. In certain embodiments, the heater 457 is positioned external to the reaction vessel 452 can improve safety. In certain embodiments, the fuel recirculation loop 460 continuously pulls heel from the bottom of the reaction vessel 452. After the heel is pulled from the bottom of the reaction vessel 452, the heel is passed through a pump 462 and into the fuel heater 457. In some embodiments, the fuel heater 457 is an electric coil heater. In some embodiments, the fuel heater 457 is a tube and shell heat exchanger. In some embodiments, within the recirculation loop 460, after passing through the fuel heater 457, the heel is returned to the reaction vessel 452. In certain embodiments, new feed fuel can also be introduced into the recirculation loop 460 between the reaction vessel 452 and the pump 462. In some embodiments, the recirculation loop 460 may further include a heel drain line 477 for removing heel from the reaction vessel 452. In certain embodiments, a heat exchanger 468 can be positioned along the heel drain line 477.

In certain embodiments, an inner height of the reaction vessel 452 can be between 45 inches and 75 inches, between 50 inches and 70 inches, between 45 inches to 55 inches, between 63 inches and 73 inches, between 65 inches and 70 inches, between 55 inches to 65 inches, or any other suitable range. In certain embodiments, the inner height of the reaction vessel 452 can be 50 inches, about 50 inches, 51 inches, about 51 inches, 59.75 inches, about 59.75 inches, 60 inches, about 60 inches, 68 inches, about 68 inches, or any other suitable height.

In certain embodiments, an inner diameter of the reaction vessel 452 can be between 15 inches and 85 inches, between 20 inches and 80 inches, between 20 inches and 30 inches, between 25 inches and 35 inches, between 25 inches and 30 inches, between 22.5 inches and 32.5 inches, between 67 inches and 77 inches, between 65 inches and 70 inches, or any other suitable range. In certain embodiments, the inner diameter of the reaction vessel can be 25.875 inches, about 25.875 inches, 26 inches, about 26 inches, 27.5 inches, about 27.5 inches, 28 inches, about 28 inches, 72 inches, about 72 inches, or any other suitable diameter.

In certain embodiments, feed fuel is introduced into the reaction vessel 452 to provide an initial liquid level between 1 inch and 30 inches, between 2 inches and 28 inches, between 2 inches and 16 inches, between 4 inches and 14 inches, between 6 inches and 12 inches, between 2 inches and 6 inches, between 8 inches and 12 inches, between 10 inches and 14 inches, between 22.5 inches and 26.5 inches, or any other suitable range. In certain embodiments, the initial liquid level can be 4 inches, about 4 inches, 10 inches, about 10 inches, 12 inches, about 12 inches, 24.5 inches, about 24.5 inches, or any other suitable liquid level.

As shown in FIG. 4, in certain embodiments, the production facility 400 can also include a product vessel 466 having a condensation medium. In certain embodiments, the production facility 400 can include a product outlet pump 459 configured to pump product through a product outlet line 475. In certain embodiments, the production facility 400 can include a feed line 465 and a feed pump 463 configured to pump feed to the reaction vessel 452. In certain embodiments, the production facility 400 can include heat exchangers 467 and 469.

In certain embodiments, the production facility 400 can include a chiller 471. In certain embodiments, the production facility 400 can include a pump 447 for introducing gas, such as methane, into the reaction vessel 452. In certain embodiments, the pump 447 can deliver unreacted gas from the product vessel 466 and/or gas from a gas feed line 473 to the reaction vessel 452. In certain embodiments, the pump 447 is a vacuum blower pump.

### EXAMPLE 1

This example illustrates the systems and processes of the present application as applied to natural gas as the methane-containing gas and diesel oil as the liquid petroleum fraction. The equipment used was as shown in FIG. 1, in which the reaction vessel was a tank with a volumetric capacity of 1,000 gallons (3,785 liters) and a diameter of 6.5 feet (2 meters). The tank was initially charged with 600 gallons (2,270 liters) of diesel fuel maintained at a temperature of 290° F. (143.3° C.) and a pressure of 6 psig (143 kPa), and natural gas was bubbled through the reactor at a rate of 20,000 SCFH. The catalyst grids consisted of nickel wire, tungsten wire, cobalt wire (an alloy containing approximately 50% cobalt, 10% nickel, 20% chromium, 15% tungsten, 1.5% manganese, and 2.5% iron), and aluminum wire over a gray iron frame. Once fully started, the reactor produced liquid product at a rate of 200 gallons per hour (760 liters per hour), and two gallons of product for every gallon of reaction medium depleted. All gallons listed herein are U.S. gallons.

The product was analyzed by standard ASTM protocols and the results are listed in Table I.

TABLE 1
PRODUCT TEST RESULTS

| | Protocol | Result | |
|---|---|---|---|
| Flash Point | ASTM D 93 | 64° C. | |
| Sediment and Water | ASTM D2709 | 0.000 vol % | |
| Observed barometric pressure | | 759 mm Hg | |
| Distillation corrected to 760 | ASTM D 86 | | |
| m mm Hg (1 atm) | | | |
| | | Percent | |
| | | Recovered: | Temperature |
| | | Initial b.p. | 179.9° C. |
| | | 4 | 193.8° C. |
| | | 10 | 199.5° |
| | | 15 | 203.8° C. |
| | | 20 | 208.0° C. |
| | | 30 | 216.2° C. |
| | | 40 | 223.4° C. |
| | | 50 | 230.5° C. |
| | | 60 | 238.0° C. |
| | | 70 | 247.7° C. |
| | | 80 | 257.3° C. |
| | | 85 | 264.3° C. |
| | | 90 | 272.9° C. |
| | | 95 | 287.8° C. |
| | | End | 296.1° C. |
| | | Recovery | 97.0% |

| | | |
|---|---|---|
| Viscosity @ 400 C. | ASTM D 445a-1.8 | 1.83 mm2/s |
| Ash | ASTM D 482 | <0.001 weight % |
| Sulfur by Microcoulometry | ASTM D 3120 | 5 mg/kg |
| Total Sulfur by UV Fluorescence | ASTM 5453-1.0 | 2.4 mg/kg |
| Copper Corrosion, 3 hours at 50° C. | ASTM D 130 | Ia |
| Cetane No. | ASTM D6 13 | 42.8 |
| API Gravity at 60° F. | ASTM D287 | 38.2 Deg. API |
| Aromatics | | 18.1 volume % |
| Olefins | | 1.6 volume % |
| Saturates | | 80.3 volume % |
| Cloud Point | ASTM D2500 | −44° C. |
| Ramsbottom Carbon Residue, 10% | ASTM D 524 | 0.06 weight % |
| Bottoms | | |
| Lubricity by HFRR at 60° C. | | 2809 μm |
| Total Nitrogen | ASTM D 4629 | 7.7 mg/kg |
| Total Aromatics | ASTM D 5186 | 19.2 weight % |
| Mono-Aromatics | ASTM D 5186 | 18.3 weight % |
| Polynuclear Aromatic Hydrocarbons | ASTM D 5186 | 0.9 weight % |

Electrical measurements were taken between the windings at the center of the frame and the frame at a point midway between the center and the outer edge. At steady state, the measurements at one point in time were those shown in Table II:

TABLE II
VOLTAGE GENERATED

| | Voltage | | Period | | Frequency | | Rise Time | | Fall Time | |
|---|---|---|---|---|---|---|---|---|---|---|
| Mean | 1.1 160 | V | 41.7 | msec | 75.1 | Hz | 4.8 | msec | 4.6 | msec |
| Minimum | 110 | mV | 16.4 | μsec | 2.1 | Hz | −20.6 | msec | −221.4 | μsec |
| Maximum | 4.243 | V | 482.7 | msec | 61.0 | kHz | 461.1 | msec | 463.6 | msec |

The product was used as fuel in an F-150 Ford pick-up truck for city driving in Reno, Nevada, USA, to achieve a mileage of 14 miles/gal. The same pick-up truck normally obtains 10 miles/gal on gasoline. The product was also used as fuel in Mercedes Benz 320S automobile in city driving in Reno, Nevada, USA, to achieve mileage of 30 miles/gal. With commercial diesel fuel, the same vehicle obtained 18 miles/gal. The product was also used on a Hummer 1 automobile in city driving in Reno, Nevada, USA, to achieve mileage of 12 miles/gal. With commercial diesel fuel, the same vehicle obtained 7 miles/gal.

### EXAMPLE 2

This example provides the results of emissions tests on two test fuels manufactured in accordance with the systems and processes of the present application and compares these results with results obtained on commercially available No. 2 Ultra Low Sulfur Diesel (ULSD) fuel, all tests conducted in heavy-duty on-road diesel engines using the EPA Transient Cycle Heavy-Duty Test Protocol. The two test fuels were manufactured under the same conditions and in the same equipment as that of Example 1, with kerosene as the liquid petroleum faction in the first test fuel and No. 2 ULSD as the liquid petroleum faction in the second test fuel, and natural gas (95% methane) as the methane-containing gas for both.

The heavy duty test engine used in the tests was a 1990 model year Caterpillar diesel engine, Model No. 3406B. The test protocol is one that is currently used for emission testing of heavy-duty on-road engines in the United States, pursuant to 40 CFR § 86.1333. The test begins with a cold start after parking overnight, followed by idling, acceleration, and deceleration phases and subjects the engine to a wide variety of speeds and loads sequenced in a computer-controlled automatic engine dynamometer to simulate the running of the vehicle. There are few stabilized running conditions, and the average load factor is about 20% to 25% of the maximum horsepower available at a given speed. The test cycle is twenty minutes in duration and two such cycles are performed, the first from a cold start and the second from a hot start twenty minutes after the end of the first cycle. The equivalent average speed is about 30 km/h and the equivalent distance traveled for each cycle is 10.3 km. Emissions that were continuously measured and recorded every second included total hydrocarbons (THC), methane (CH4), non-methane hydrocarbons (NMHC=THC−CH₄), carbon monoxide (CO), carbon dioxide (CO₂), oxides of nitrogen (NOₓ), and nitrous oxide (NO₂). Fuel consumption was measured gravimetrically and reported in grams per brake horsepower per hour (g/bhp-hr). Particulate matter (PM) was captured over the entire test cycle on a single filter medium and weighed. A non-dispersive infrared detector was used for measuring CO and CO₂, a flame ionization detector was used for measuring THC and CH₄, a heated chemiluminescent detector was used for measuring NOₓ and NO, and PM was measured by a primary tunnel dilution followed by secondary tunnel dilution in a Model SPC-472 Smart Sampler of AVL Powertrain Engineering, Inc. The raw data were corrected by the computer for temperature, barometric pressure, and humidity, as well as for any hydrocarbons and carbon monoxide present in the dilution air, and expressed as grams per brake horsepower per hour.

The results are shown in Tables III and IV, where the “Baseline” values represent the results obtained with the commercially obtained No. 2 ULSD diesel fuel.

TABLE III
EMISSION TEST RESULTS-RAW DATA

| | bhp/hr | | g/bhp-hr | | | | | | |
|---|---|---|---|---|---|---|---|---|---|
| | Demand | Actual | TCH | NMHC | CO | NOx | CO, | Fuel | PM |
| Baseline | 24.37 | 23.01 | 4.20 | 3.94 | 64.5 | 223.4 | 15172.6 | 4371.5 | 0.224 |
| Test Fuel | 24.38 | 22.67 | 5.85 | 5.61 | 64.7 | 208.0 | 14902.0 | 4364.0 | 0.243 |
| No. 1 | | | | | | | | | |
| Deviation | | −1.5% | 39.3% | 42.4% | 0.3% | −10.9% | −1.8% | −0.2% | 8.5% |
| from | | | | | | | | | |
| Baseline | | | | | | | | | |
| Test Fuel | 24.37 | 22.83 | 4.87 | 4.22 | 66.2 | 215.5 | 15932.5 | 4388.0 | 0.214 |
| No. 2 | | | | | | | | | |
| Deviation | | −0.8% | 16.0% | 7.1% | 2.6% | −7.7% | −1.6% | 0.4% | −4.5% |
| from | | | | | | | | | |
| Baseline | | | | | | | | | |

TABLE IV
EMISSION TEST RESULTS-CORRECTED

| | bhp/hr | | g/bhp-hr | | | | | | |
|---|---|---|---|---|---|---|---|---|---|
| | Demand | Actual | TCH | NMHC | CO | NOx | CO, | Fuel | PM |
| Baseline | 24.37 | 23.01 | 0.18 | 0.17 | 2.81 | 10.15 | 659.46 | 0.4189 | 0.224 |
| Test Fuel | 24.38 | 22.67 | 0.26 | 0.25 | 2.86 | 9.18 | 657.41 | 0.4244 | 0.243 |
| No. 1 | | | | | | | | | |
| Deviation | | −1.5% | 4.44% | 47.1% | 1.8% | −9.6% | −0.3% | 1.3% | 8.5% |
| from | | | | | | | | | |
| Baseline | | | | | | | | | |
| Test Fuel | 24.37 | 22.83 | 0.20 | 0.18 | 2.90 | 9.44 | 654.13 | 0.4238 | 0.214 |
| No. 2 | | | | | | | | | |
| Deviation | | −0.8% | 11.1% | 5.9% | 3.2% | −7.0% | −0.8% | 1.2% | −4.5% |
| from | | | | | | | | | |
| Baseline | | | | | | | | | |

### EXAMPLE 3

This example illustrates the systems and processes of the present application in a process utilizing natural gas and Trap Springs crude oil (Railroad Valley, Nye County, Nevada, USA). The equipment used was as shown in FIG. 2, with a tank having a volumetric capacity of 50 gallons (190 liters) as the reaction vessel. The tank was initially charged with 12 gallons (45 liters) of the crude oil and was maintained at a temperature of 340° F. (171° C.) and a pressure of 3.5 psig (125 kPa). The natural gas was bubbled through the crude oil at a rate of 210 SCFH. The catalyst grids consisted of nickel wire, tungsten wire, cobalt wire (an alloy containing approximately 50% cobalt, 10% nickel, 20% chromium, 15% tungsten, 1.5% manganese, and 2.5% iron), and aluminum wire over a gray iron frame. Once fully started, the vapors drawn from the tank head space were condensed to produce liquid product at a rate of 3.5 gallons per hour (13.25 liters per hour), and two gallons of the liquid product, termed a first stage product, were produced for every gallon of reaction medium depleted. (All gallons listed herein are U.S. gallons.) Residual crude oil was then removed from the tank and replaced with twelve gallons of the first stage product, and the process repeated, i.e., further natural gas was bubbled through the first-stage product in the tank under the same conditions as when the tank contained the crude oil. The vapors drawn from the tank head space were condensed as they were formed, and the condensate was collected as a second stage product.

The test results on the initial crude oil and samples of both the first stage product and the second stage product, in both cases after one hour of operation, are listed in Table V.

TABLE V
RAW MATERIAL AND PRODUCT DATA

| Test and Protocol | Results | | | | | | |
|---|---|---|---|---|---|---|---|
| Distillation corrected to 760 mm Hg (I atm); | | | | | | | |
| ASTM D86 | | Temperature (° C.) | | | | | |
| | Percent Recovered | Crude Oil | | 1^{st} Stage Product | | 2^{nd} Stage Product | |
| | 0^{(D} | 114.7 | | 91.5 | | 134.6 | |
| | 5 | 179.3 | | 130.1 | | 153.7 | |
| | 10 | 215.5 | | 142.3 | | 162.5 | |
| | 15 | 246.7 | | 153.1 | | 169.6 | |
| | 20 | 273.9 | | 162.7 | | 175.4 | |
| | 30 | 352.9 | | 181.6 | | 186.8 | |
| | 40 | 359.6 | | 199.8 | | 197.1 | |
| | 50 | 439.6 | | 216.7 | | 206.9 | |
| | 60 | 348.8 | | 233.2 | | 216.9 | |
| | 70 | —⁽²⁾ | | 248.1 | | 226.8 | |
| | 80 | — | | 264.0 | | 238.0 | |
| | 85 | — | | 273.9 | | 245.1 | |
| | 90 | — | | 286.5 | | 2542 | |
| | 95 | — | | 309.7 | | 270.1 | |
| | End | — | | 315.1 | | 283.4 | |
| | Recovery | 70 | | 97% | | 97.3% | |
| API Gravity at 60° C.; | | 23.2° | API | 44.0° | API | 46.0° | API |
| ASTM D287 | | | | | | | |
| Sulfur by | | 19,800 | mg/kg | 2,800 | mg/kg | 1,400 | mg/kg |
| Microcoulometry; | | | | | | | |
| ASTM D3120 | | | | | | | |
| Viscosity @ 40° C.; | | 75.32 | mm²/s | 1.43 | mm²/s | 1.34 | mm²/s |
| ASTM D 334a-1.8 | | | | | | | |

| Flash Point; ASTM | 35.0° | C. |
|---|---|---|
| D93 (Proc. A) | | |
| Ash; ASTM D482 | <0.001% | (wt) |
| Copper Corrosion @ | IA 3 | hours |
| 50° C.; ASTM D130 | | |
| Cloud Point; ASTM | −48° | c. |
| D2500 | | |
| Ramsbottom Carbon | 0.09% | (wt) |
| 10% Residue; ASTM | | |
| D524 | | |
| Cetane Index; ASTM | 48.5 | |
| D976 | | |
| Lubricity by HFRR⁽³⁾ | 40 | μm |
| at 60° C.; ASTM | | |

⁽¹⁾Initial boiling point
⁽²⁾Sample would not distill past 70% recovery
⁽³⁾High-Frequency Reciprocating Rig

### EXAMPLE 4

This example illustrates the systems and processes of the present application as applied to natural gas as the methane-containing gas and Ultra Low Sulfur Diesel (ULSD) fuel as the liquid petroleum fraction. The equipment used was as shown in FIG. 4. In Example 4, the reaction vessel was a stainless steel tank with a volumetric capacity of 114 gallons (431.5 liters) and an inner diameter of 25.875 inches. The tank had a height of 50 inches. The tank was initially charged with 30 gallons of ULSD fuel. The initial charging included filling the heater and recirculation. After the initial charge, the ULSD fuel was at a level of 4 inches within the tank. The fuel was maintained at a temperature between 290° F. (143.3° C.) to 295° F. (146.1° C.). In some embodiments, 295° F. (146.1° C.) is a preferred reaction medium liquid temperature. In some embodiments, variations in temperature can occur due to varying feedstock and gas temperatures. The reaction vessel was maintained at a pressure of 5 psi. Natural gas was bubbled through the reactor with a bubble size of 20 micron distributed through two 12 inch mesh gas spargers and two 8 inch mesh gas spargers placed two inches above the bottom of the tank. Natural gas was bubbled through the reactor at a rate of 140 SCFM, corresponding to 30% of the maximum pump output. The gas spargers were arranged such that the two 12 inch spargers were positioned between the two 8 inch spargers. Each of the gas spargers was fed by an individual gas pipe extending from a main return gas line from the pump. The pump was a vacuum blower. The gas source was city natural gas provided by Piedmont Natural Gas. The catalyst grids consisted of six catalyst grids, each grid having an individual 24 inch diameter cast iron grate wound in sequence with parallel nickel, nickel chromium, aluminum, and cobalt wire having a spacing of 0.5 mm between wires and a with a perpendicular tungsten wire at a spacing of 3 in. The catalyst grids were positioned in a Teflon canister to shield them from walls of the tank. Once fully started, the reactor produced liquid product at a rate of 17 gallons per minute, and one gallon of product for every gallon of reaction medium depleted. All gallons listed herein are U.S. gallons.

Three product samples were taken (Samples 25, 50, and 105 in Table VI) during a continuous 65 minute run on July 11, 2019, in which a continuous feed was provided. Cycled venting and new methane introduction were also utilized. Sample 25, Sample 50, and Sample 105 were taken at 25 minutes, 50 minutes, and 65 minutes of the continuous 65 minute run. During the 65 minute run, the reaction vessel levels remained constant. The product vessel was drained after each sample was taken.

Each sample was subjected an ASTM D3699 Kerosene analysis matrix. The samples were analyzed by standard ASTM protocols and the results are listed in Table

VI.

TABLE VI

| | | | | | Sample | Sample | Sample |
|---|---|---|---|---|---|---|---|
| | ASTM | | | | ID: | ID: | ID: |
| | Procedure/ | | | | 25, | 50, | 105, |
| Test | Rev. | Unit | Min | Max | Fuel | Fuel | Fuel |
| Seta Flash @ | 3828-2.4 | Pass/ | Pass | | Pass | Pass | Pass |
| 38 C. | | Fail | | | | | |
| Viscosity @ | 0445A-2.1 | mm2/s | 1.00 | 1.90 | 1.35 | 1.71 | 1.73 |
| 40 C. | | | | | | | |
| Distillation of | 0086-2.7 | | | | | | |
| Petroleum | | | | | | | |
| Observed | | mm | | | 762 | 762 | 761 |
| Barometric | | Hg | | | | | |
| Pressure | | | | | | | |
| All results | | | | | | | |
| corrected to | | | | | | | |
| 760 mm Hg | | | | | | | |
| Initial boiling | | Deg. | | | 167.8 | 170.9 | 170.5 |
| point | | C. | | | | | |
| 5% recovered | | Deg. | | | 180.0 | 188.3 | 187.7 |
| | | C. | | | | | |
| 10% | | Deg. | | 205.0 | 183.6 | 193.1 | 193.1 |
| recovered | | C. | | | | | |
| 15% | | Deg. | | | 186.5 | 197.6 | 197.5 |
| recovered | | C. | | | | | |
| 20% | | Deg. | | | 189.4 | 202.0 | 201.2 |
| recovered | | C. | | | | | |
| 30% | | Deg. | | | 195.4 | 210.4 | 210.5 |
| recovered | | C. | | | | | |
| 40% | | Deg. | | | 201.0 | 218.2 | 218.4 |
| recovered | | C. | | | | | |
| 50% | | Deg. | | | 206.3 | 225.6 | 226.4 |
| recovered | | C. | | | | | |
| 60% | | Deg. | | | 212.4 | 233.3 | 235.0 |
| recovered | | C. | | | | | |
| 70% | | Deg. | | | 219.9 | 241.7 | 244.6 |
| recovered | | C. | | | | | |
| 80% | | Deg. | | | 229.9 | 251.7 | 255.4 |
| recovered | | C. | | | | | |
| 85% | | Deg. | | | 236.9 | 257.9 | 262.0 |
| recovered | | C. | | | | | |
| 90% | | Deg. | | | 245.8 | 265.7 | 269.9 |
| recovered | | C. | | | | | |
| 95% | | | | | 206.0 | 276.9 | 281.8 |
| recovered | | | | | | | |
| End Point | | Deg. | | 300.0 | 279.9 | 294.3 | 296.9 |
| | | C. | | | | | |
| Recovery | | % vol. | | | 98.8 | 99.4 | 99.0 |
| Sulfur, X-Ray | 4294-2.8 | % Wt | | 0.0400 | 0.0026 | 0.0022 | 0.0022 |
| Fluorescense | | | | | | | |
| Copper | 0130-3.4 | 3 | | 3 | 1A | 1A | 1A |
| Corrosion | | Hours | | | | | |
| @ 100 deg C. | | | | | | | |
| Freeze Pt. of | 2386-1.0 | Deg. | | (−) | (−) 54.0 | (−) 36.0 | (−) 35 |
| Aviation | | C. | | 30.0 | | | |
| Fuels | | | | | | | |
| Saybolt Color | 0156-1.2 | | (+) | | (+) 27 | (+) 25 | (+) 25 |
| | | | 16 | | | | |
| Active Sulfur | 4952-1.0 | | | | Sweet | Sweet | Sweet |
| in Fuels | | | | | | | |
| (Doctor Test) | | | | | | | |
| Burning | 0187-1.0 | | | | | | |
| Quality of | | | | | | | |
| Kerosene | | | | | | | |
| Average | | g/hr | 18 | 26 | 19 | 16 | 18 |
| Burning Rate | | | | | | | |
| Initial Flame | | mm | | | 25 | 25 | 25 |
| Height | | | | | | | |
| Final Flame | | mm | | | 25 | 25 | 25 |
| Height | | | | | | | |
| Change in | | mm | | 5 | 0 | 0 | 0 |
| Flame Height | | | | | | | |
| Initial Flame | | mm | | | 25 | 25 | 25 |
| Width | | | | | | | |
| Final Flame | | mm | | | 25 | 25 | 25 |
| Width | | | | | | | |
| Change in | | mm | | 6 | 0 | 0 | 0 |
| Flame Width | | | | | | | |
| Density of | | | | | None | None | None |
| Chimney | | | | | | | |
| Deposit | | | | | | | |
| Color of | | | | | None | None | None |
| Chimney | | | | | | | |
| Deposit | | | | | | | |

As shown in Table VI, it was found that the Samples 25 and 105 each met the full ASTM D3699 kerosene standards while Sample 50 failed only the standard for Rate of Burning under D187 Burn Quality Testing. Table VI demonstrates that it is possible to produce a lower sulfur kerosene product from a ULSD reaction medium under certain conditions. As shown in Tables 1 and 2, in other embodiments, an altered or improved diesel fuel may be produced from a diesel or ULSD reaction medium using the systems and processes described herein.

The base diesel and the heel (residual product left in the reaction vessel) were also tested under an ASTM D976 standard diesel analysis matrix. The base diesel and heel were analyzed by standard ASTM protocols and the results are listed in Table VII.

TABLE VII

| | | | | | Sample | Sample |
|---|---|---|---|---|---|---|
| | | | | | ID: | ID: |
| | ASTM | | | | Feed, | Heel, |
| | Procedure/ | | | | Diesel | Diesel |
| Test | Rev. | Unit | Min | Max | Fuel | Fuel |
| Flash Point | 0093-1.8 | Deg. | 52.0 | | 64.0 | 121.0 |
| PmCC (Proc. A) | | C. | | | | |
| Sediment and | 2709-1.2 | % Vol | | 0.050 | 0.000 | <0.005 |
| Water | | | | | | |
| Distillation of | 0086-2.7 | | | | | |
| Petroleum | | | | | | |
| Observed | | mm | | | 761 | 762 |
| Barometric | | Hg | | | | |
| Pressure | | | | | | |
| All results are | | | | | | |
| corrected to 760 | | | | | | |
| mm Hg | | | | | | |
| Initial Boiling | | Deg | | | 171.0 | 255.1 |
| point | | C. | | | | |
| 5% recovered | | Deg | | | 188.5 | 268.6 |
| | | C. | | | | |
| 10% recovered | | Deg | | | 196.1 | 273.8 |
| | | C. | | | | |
| 15% recovered | | Deg | | | 201.6 | 277.1 |
| | | C. | | | | |
| 20% recovered | | Deg | | | 208.5 | 280.8 |
| | | C. | | | | |
| 30% recovered | | Deg | | | 222.0 | 287.6 |
| | | C. | | | | |
| 40% recovered | | Deg | | | 235.5 | 294.3 |
| | | C. | | | | |
| 50% recovered | | Deg | | | 249.5 | 300.9 |
| | | C. | | | | |
| 60% recovered | | Deg | | | 264.8 | 308.2 |
| | | C. | | | | |
| 70% recovered | | Deg | | | 281.3 | 317.2 |
| | | C. | | | | |
| 80% recovered | | Deg | | | 298.5 | 328.1 |
| | | C. | | | | |
| 85% recovered | | Deg | | | 308.7 | 335.7 |
| | | C. | | | | |
| 90% recovered | | Deg | 282.0 | 338.0 | 321.1 | 346.0 |
| | | C. | | | | |
| 95% recovered | | Deg | | | 341.4 | 362.2 |
| | | C. | | | | |
| End Point | | Deg | | | 357.6 | 368.9 |
| | | C. | | | | |
| Recovery | | % vol. | | | 98.6 | 97.7 |
| Viscosity @ 40 | 0445A-2.1 | mm2/s | 1.90 | 4.10 | 2.40 | 5.02 |
| Deg C. | | | | | | |
| Ash | 0482-2.5 | mass | | 0.010 | <0.001 | <0.001 |
| | | % | | | | |
| Sulfur by | 3120-3.1 | mg/kg | | 15 | 4 | 6 |
| Microcoulometry | | | | | | |
| Copper | 0130-3.4 | 3 | | 3 | 1A | 1A |
| Corrosion | | Hours | | | | |
| Cloud Point | 2500-1.5 | Dec. | | | (−) 8 | (−) 1 |
| | | C. | | | | |
| Ramsbottom | 0524-2.4 | % wt | | 0.35 | 0.09 | <0.01 |
| Carbon 10% | | | | | | |
| Residue | | | | | | |
| Cetane Index | 0976-1.3 | | 40.0 | | 48.5 | 53.5 |
| Lubricity by | 6079-1.2 | um | | 520 | 430 | 320 |
| HFRR at 60° C. | | | | | | |
| API Gravity | 0287-2.2 | Deg. | | | 38.1 | 35.3 |
| | | API | | | | |
| Cetane No. of | 0613-1.0 | | | | 51.3 | 61.0 |
| Diesel Fuel | | | | | | |

### EXAMPLE 5

Example 5 is another example illustrating the systems and processes of the present application as applied to natural gas as the methane-containing gas and Ultra Low Sulfur Diesel (ULSD) fuel as the liquid petroleum fraction. The equipment used was as shown in FIG. 4. In Example 5, the reaction vessel was a tank with a volumetric capacity of 1000 gallons (3785.4 liters) and an inner diameter of 72 in. The tank has a height of 68 in. Two series of tests were performed. The first series included a first test and a second test performed on July 25, 2019, and a third test performed on July 26, 2019. The second series included a fourth test performed on August 6, 2019.

In the first test, the tank was initially charged with 363 gallons of ULSD fuel. The initial charging included filling the heater and recirculation. The fuel was maintained at a temperature between 290° F. (143.3° C.) to 295° F. (146.1° C.). In some embodiments, 295° F. (146.1° C.) is a preferred reaction medium liquid temperature. In some embodiments, variations in temperature can occur due to varying feedstock and gas temperatures. The reaction vessel was maintained at a pressure of 10 psi. Natural gas was bubbled through the reactor by 13 gas spargers with hole sizes varying between 2 mm and 6 mm. Natural gas was bubbled through the reactor at a rate of 475 SCFM, corresponding to 95% of the maximum pump output. The catalyst grids consisted of four catalyst grids as described with respect to FIGS. 1-3. Once fully started, the reactor produced liquid product at a rate of 30 gallons per hour, and one gallon of product for every gallon of reaction medium depleted. All gallons listed herein are U.S. gallons.

Two product samples were taken (Samples GKA and GKB) at different times on the same day during a first test (Sample GKA) and a second test (Sample GKB). After each run, the product tank was completely drained, but the heel was not drained. The Samples GKA and GKB were taken halfway through the draining of the product tank after their respective test runs. Reaction vessel levels stayed constant for each sample. During test 1, for Sample GKA, the liquid within the reaction vessel was maintained at a level of 10 inches. After the draining of the product tank and collection of Sample GKA, the heel remaining in the reaction vessel was at a level of 10 inches, corresponding to 363 gallons. During the first test, new methane was constantly introduced. No venting was performed.

Prior to the second test, for Sample GKB, an additional 17.75 gallons per inch of ULSD fuel were added to the reaction vessel to bring the liquid level in the reaction vessel to 12 in, corresponding to a total volume of liquid in the reaction vessel of 298.5 gallons. For Sample GKB, the liquid level within the reaction vessel was maintained at a level of 12 inches. During the second test, new methane was constantly introduced. No venting was performed. The heel was not drained after the second test. After the second test, the level of the heel within the reaction vessel was 12 inches.

Prior to the third test, the level of heel in the reaction vessel was 12 inches corresponding to 398.5 gallons. An additional 17.75 gallons per inch of ULSD fuel were added to the reaction vessel to bring the liquid level in the reaction vessel to 16 inches, corresponding to a total volume of liquid in the reaction vessel of 469.5 gallons.

One product sample (Sample GKC) was taken during the third test. Sample GKC was taken halfway through the draining of the product tank following the third test. During the third test, new methane was constantly introduced. No venting was performed.

Sample GKD is a mix consisting of 16.66% Sample GKA, 16.66% Sample GKB, and 66.66% Sample GKC.

Sample GKD was subjected an ASTM D3699 Kerosene analysis matrix. Samples GKA, GKB, and GKC were subjected to certain tests of the ASTM D3699 Kerosene analysis matrix. The samples were analyzed by standard ASTM protocols and the results are listed in Table VIII.

TABLE VIII

| | ASTM | | | | Sample | Sample | Sample | Sample |
|---|---|---|---|---|---|---|---|---|
| | Procedure/ | | | | ID: | ID: | ID: | ID: |
| Test | Rev. | Unit | Min | Max | GKA | GKB | GKC | GKD |
| Corrected | D56 | ° C. | 38 | | 39.5 | 38.0 | | 50.0 |
| Flash Point | | | | | | | | |
| by TCC | | | | | | | | |
| Distillation | D86 | | | | | | | |
| IPB | | ° C. | | | 140.9 | 161.5 | 174.9 | 160.6 |
| 10% | | ° C. | 205 | | 163.8 | 186.0 | 202.0 | 191.0 |
| recovery | | | | | | | | |
| 50% | | ° C. | | | 196.8 | 223.9 | 238.3 | 230.3 |
| recovery | | | | | | | | |
| 90% | | ° C. | | | 241.8 | 266.1 | 272.9 | 270.4 |
| recovery | | | | | | | | |
| FBP | | ° C. | 300 | | 276.0 | 295.7 | 298.0 | 296.6 |
| Recovery | | % vol | | | 97.8 | 98.1 | 97.5 | 98.3 |
| Residue | | % vol | | | 1.5 | 1.5 | 1.5 | 1.5 |
| Loss | | % vol | | | 0.7 | 0.4 | 0.1 | 0.2 |
| Kinematic | D445 | cSt | 1.0 | 1.9 | 1.267 | 1.685 | 1.916 | 1.771 |
| Viscosity @ | | | | | | | | |
| 40 C. | | | | | | | | |
| Total Sulfur | D2622 | mass | | 0.04 | | | | 0.00030 |
| Content | | % | | | | | | |
| Mercaptan | D3227 | mass | | 0.003 | | | | <0.003 |
| Sulfur | | % | | | | | | |
| Copper Strip | D130 | | | 3 | | | | 1A |
| Corrosion | | | | | | | | |
| Rating | | | | | | | | |
| Freezing | D2386 | ° C. | | (−) 30 | | | | (−) 41.0 |
| Point | | | | | | | | |
| Burning | D187 | | | | | | | |
| Quality | | | | | | | | |
| (Kerosene) | | | | | | | | |
| Time of | | hr | 16 | | | | | 16 |
| Burning | | | | | | | | |
| Chimney | | | | Light | | | | Light |
| Appearance | | | | White | | | | |
| Flame | | mm | | 5 | | | | 1 |
| Characteristic- | | | | | | | | |
| Varience of | | | | | | | | |
| flame width | | | | | | | | |
| Flame | | mm | | 6 | | | | 3 |
| Characteristic- | | | | | | | | |
| Varience of | | | | | | | | |
| flame height | | | | | | | | |
| Rate of | | g/hr | 18 | 26 | | | | 16 |
| Burning | | | | | | | | |
| Saybolt | D156 | | 16 | | | | | (+) 30 |
| Color | | | | | | | | |

The fourth test was preformed using the same system as described for the first through third tests. In the fourth test, the tank was initially charged with 363 gallons of ULSD fuel. The initial charging included filling the heater and recirculation. The fuel was maintained at a temperature between 290° F. (143.3° C.) to 295° F. (146.1° C.). In some embodiments, 295° F. (146.1° C.) is a preferred reaction medium liquid temperature. In some embodiments, variations in temperature can occur due to varying feedstock and gas temperatures. The reaction vessel was maintained at a pressure of 10 psi. Natural gas was bubbled through the reactor at a rate of 475 SCFM, corresponding to 95% of the maximum pump output. Once fully started, the reactor produced liquid product at a rate of 30 gallons per hour, and one gallon of product for every gallon of reaction medium depleted. All gallons listed herein are U.S. gallons.

Two product samples were taken (Samples GKE and GKF) during at different times on the same day during a continuous run. The heel in the reaction vessel at the beginning of the fourth test was at a level of 10 inches, corresponding to 363 gallons. Sample GKE was taken 1 hour into the fourth test when the heel in the reaction vessel was at a level of 11 inches. Sample GKF was taken at the end of the run when the heel in the reaction vessel was at a level of 15 inches. The total time for the fourth test run was about 4 hours. The reaction vessel levels remained constant during the test run. During the fourth test, new methane was constantly introduced. No venting was performed. Sample GKG is a mix consisting of 50% Sample GKE and 50% Sample GKF.

Sample GKG was subjected an ASTM D3699 Kerosene analysis matrix. Samples GKE and GKF were subjected to certain tests of the ASTM D3699 Kerosene analysis matrix. The samples were analyzed by standard ASTM protocols and the results are listed in Table IX.

TABLE IX

| | ASTM | | | | Sample | Sample | Sample |
|---|---|---|---|---|---|---|---|
| | Procedure/ | | | | ID: | ID: | ID: |
| Test | Rev. | Unit | Min | Max | GKE | GKF | GKG |
| Corrected | D56 | ° C. | 38 | | | | 39.4 |
| Flash Point | | | | | | | |
| by TCC | | | | | | | |
| Distillation | D86 | | | | | | |
| IPB | | ° C. | | | | | 149.1 |
| 10% | | ° C. | 205 | | | | 173.4 |
| recovery | | | | | | | |
| 50% | | ° C. | | | | | 204.8 |
| recovery | | | | | | | |
| 90% | | ° C. | | | | | 252.0 |
| recovery | | | | | | | |
| FBP | | ° C. | 300 | | | | 282.1 |
| Recovery | | % vol | | | | | 97 |
| Residue | | % vol | | | | | 1.5 |
| Loss | | % vol | | | | | 1.5 |
| Kinematic | D445 | cSt | 1.0 | 1.9 | | | 1.313 |
| Viscosity @ | | | | | | | |
| 40 C. | | | | | | | |
| Total Sulfur | D2622 | mass | | 0.04 | | | 0.00006 |
| Content | | % | | | | | |
| Mercaptan | D3227 | mass | | 0.003 | | | <0.0003 |
| Sulfur | | % | | | | | |
| Copper Strip | D130 | | | 3 | | | 1A |
| Corrosion | | | | | | | |
| Rating | | | | | | | |
| Freezing | D2386 | ° C. | | (−) 30 | (−) 61.5 | (−) 52 | (−) 55.5 |
| Point | | | | | | | |
| Burning | D187 | | | | | | |
| Quality | | | | | | | |
| (Kerosene) | | | | | | | |
| Time of | | hr | 16 | | | | 16 |
| Burning | | | | | | | |
| Chimney | | | | Light | | | Light |
| Appearance | | | | White | | | White |
| Flame | | mm | | 5 | | | 2 |
| Characteristic- | | | | | | | |
| Varience of | | | | | | | |
| flame width | | | | | | | |
| Flame | | mm | | 6 | | | 4 |
| Characteristic- | | | | | | | |
| Varience of | | | | | | | |
| flame height | | | | | | | |
| Rate of | | g/hr | 18 | 26 | | | 19 |
| Burning | | | | | | | |
| Saybolt | D156 | | 16 | | | | (+) 30 |
| Color | | | | | | | |

As shown in Tables VIII and IX, it was found that the Sample GKG met the full ASTM D3699 kerosene standards while Sample GKD failed only the standard for Rate of Burning under D187 Burn Quality Testing.

As demonstrated by the freezing point data for measurements for samples GKE and GKF, it was observed that the product became heavier over time.

### EXAMPLE 6

Example 6 is another example illustrating the systems and processes of the present application as applied to natural gas as the methane-containing gas and Ultra Low

Sulfur Diesel (ULSD) fuel (10 ppm) as the liquid petroleum fraction feedstock. The equipment used was as shown in FIG. 4. In Example 6, the reaction vessel was a tank with a volumetric capacity of 152 gallons and an inner diameter of 28 inches. The tank has a height of 51 inches.

In Example 6, the tank was initially charged with 92 gallons of ULSD fuel. The initial charging included filling the heater and recirculation. After the initial charge, the ULSD fuel was at a level of 24.5 in. The fuel was maintained at a temperature between 290° F. (143.3° C.) to 295° F. (146.1° C.). In some embodiments, 295° F. (146.1° C.) is a preferred reaction medium liquid temperature. In some embodiments, variations in temperature can occur due to varying feedstock and gas temperatures. The reaction vessel was maintained at a pressure of 4.5 psi. Natural gas was bubbled through the reactor by 2 number of gas spargers with hole sizes varying between 10 micron and 20 micron. Natural gas was bubbled through the reactor at a rate of 170 SCFM, corresponding to 48% of the maximum pump output. The catalyst grids consisted of six catalyst grids as described with respect to FIGS. 1-3. The speed of the aerosol droplets as the aerosol droplets passed through the catalyst grids was 0.285 m/s. Once fully started, the reactor produced liquid product at a rate of 26.5 gallons per hour, and one gallon of product for every gallon of reaction medium depleted. All gallons listed herein are U.S. gallons.

Table X shows test results for a sample of the ULSD liquid petroleum fraction feedstock. The product sample was subjected to certain tests of the ASTM D3699 Kerosene analysis matrix. The product sample (Sample Number XX956537) was analyzed by standard ATSM protocols and the results are listed in Table XI.

TABLE X

| Test | Method | Unit | Result |
|---|---|---|---|
| Cetane Index (4 | ISO 4264 | | 51.2 |
| equation) | | | |
| Density at 15° C. | EN ISO 12185 | kg/m³ | 826.6 |
| Flash Point PM - proc. A | EN ISO 2719 | Deg C. | 59.9 |
| Viscosity at 40° C. | EN ISO 3104 | mm²/s | 2.142 |
| Cloud Point | EN 23015 | Deg C. | <−30 |
| Distillation | EN ISO 3405 | | — |
| _Initial Boiling Point | | Deg C. | 164.8 |
| (IBP) | | | |
| _10% vol recovered | | Deg C. | 202.2 |
| _20% vol recovered | | Deg C. | 214.6 |
| _30% vol recovered | | Deg C. | 228.2 |
| _40% vol recovered | | Deg C. | 240.2 |
| _50% vol recovered | | Deg C. | 249.9 |
| _60% vol recovered | | Deg C. | 258.3 |
| _70% vol recovered | | Deg C. | 267.3 |
| _80% vol recovered | | Deg C. | 277.8 |
| _90% vol recovered | | Deg C. | 294.4 |
| _95% vol recovered | | Deg C. | 312.5 |
| _Final Boiling Point | | Deg C. | 328.9 |
| (FBP) | | | |
| _Recovered at 250° C. | | % v/v | 50.09 |
| _Recovered at 350° C. | | % v/v | — |
| _Residue | | % v/v | 2.3 |
| _Loss | | % v/v | 0 |

TABLE XI

| | | | | Limit values ASTM D3699 | |
|---|---|---|---|---|---|
| Parameter | Method | Units | XX956537 | min. | max. |
| Flash point | ISO 13756 | ° C. | 43 | 38 | |
| Distillation | ASTM D86 | | | | |
| temperature | | | | | |
| 10% volume | | ° C. | 168.8 | | 205 |
| recovered | | | | | |
| Final boiling | | ° C. | 285.0 | | 300 |
| point | | | | | |
| Kinematic | ASTM | mm²/s | 1.198 | 1.0 | 1.9 |
| viscosity at | D445 | | | | |
| 40° C. | | | | | |
| Sulfur | EN | mg/kg | 1.21 | | |
| | ISO | | | | |
| | 20884 | | | | |
| Mercaptan Sulfur | ASTM | % mass | 0.000102 | | 0.003 |
| | D3227 | | | | |
| Copper strip | ASTM | rating | 1a | | No. 3 |
| corrosion | D130 | | | | |
| test 3 h @ | | | | | |
| 100° C. | | | | | |
| Freezing point | ASTM | ° C. | −51.2 | | −30 |
| | D2386 | | | | |
| Char Value | IP 10 | mg/kg | 6.8 | | 20 |
| Saybolt color | ASTM | | +30 | +16 | |
| | D156 | | | | |
| Density at 15° C. | ASTM | kg/m³ | 805.9 | 780 | 810 |
| | D4052 | | | | |

Table XII shows a comparison of the test results for the sample of the ULSD liquid petroleum fraction feedstock shown in Table X and the test results for the product sample shown in Table XI.

TABLE XII

| | | | | Product | Kerosene Limit Values | |
|---|---|---|---|---|---|---|
| | Method | | Feedstock | Kerosene | (ASTM D3699) | |
| Parameter | (Diesel/Kerosene) | Units | Diesel | BO | Min | Max |
| Flash Point | EN ISO 2719/ | ° C. | 59.9 | 43 | 38 | |
| | ISO 13756 | | | | | |
| Distillation | EN ISO 3405/ | | | | | |
| | ASTM D86 | | | | | |
| 10% | | ° C. | 202.2 | 168.8 | | 205 |
| volume | | | | | | |
| recovered | | | | | | |
| Final | | ° C. | 328.9 | 285 | | 300 |
| Boiling | | | | | | |
| Point | | | | | | |
| Kinematic | EN ISO 3104/ | mm | 2.142 | 1.198 | 1.0 | 1.9 |
| Viscosity | ASTM D445 | 2/s | | | | |
| @ 40° C. | | | | | | |
| Density at | EN ISO | kg/m³ | 826.6 | 805.9 | 780 | 810 |
| 15° C. | 12185ASTM | | | | | |
| | D4052 | | | | | |
| Sulfur | EN ISO 20884 | mg/kg | | 1.21 | | |
| Mercaptan | ASTM D3227 | % | | 0.000102 | | 0.003 |
| Sulfur | | mass | | | | |
| Copper | | | | | | |
| Strip | | | | | | |
| Corrosion | | | | | | |
| test 3 h @ | ASTM D130 | rating | | 1a | | No. 3 |
| 100° C. | | | | | | |
| Freezing | ASTM D2386 | ° C. | | −51.2 | | −30 |
| point | | | | | | |
| Char | IP 10 | mg/kg | | | | 20 |
| Value | | | | | | |
| Saybolt | ASTM D156 | | | (+) 30 | (+) 16 | |
| color | | | | | | |

As shown in Tables XI and XII, it was found that the product sample met the full ASTM D3699 kerosene standards.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

It will be appreciated that, for clarity purposes, the above description has described embodiments with reference to different functional units. However, it will be apparent that any suitable distribution of functionality between different functional units may be used without detracting from the invention. For example, functionality illustrated to be performed by separate computing devices may be performed by the same computing device. Likewise, functionality illustrated to be performed by a single computing device may be distributed amongst several computing devices. Hence, references to specific functional units are only to be seen as references to suitable means for providing the described functionality, rather than indicative of a strict logical or physical structure or organization.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ desired,' or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A method for converting an ultra low sulfur diesel fuel to a kerosene product comprising:
receiving an ultra low sulfur diesel fuel within a reaction vessel;
delivering a gas through one or more spargers positioned within a reaction vessel into the ultra low sulfur diesel fuel so as to form aerosol droplets;
passing the aerosol droplets through one or more catalyst grids positioned within the reaction vessel at a level above the ultra low sulfur diesel fuel at a speed between 0.01 m/s and 0.7 m/s;
collecting a product gas resulting from the passing of the aerosol droplets through the catalyst grids; and
condensing the product gas to form a kerosene product.

2. The method of claim 1, wherein the aerosol droplets pass through the one or more catalyst grids at a speed between 0.05 m/s and 0.65 m/s.

3. The method of claim 2, wherein the aerosol droplets pass through the one or more catalyst grids at a speed between 0.1 m/s and 0.6 m/s.

4. The method of claim 3, wherein the aerosol droplets pass through the one or more catalyst grids at a speed between 0.2 m/s and 0.5 m/s.

5. The method of claim 1, wherein the reaction vessel comprises a cylindrical reaction vessel having an inner height between 55 inches and 65 inches and an inner diameter between 22.5 inches and 32.5 inches, the method further comprising introducing ultra low sulfur diesel fuel into the reaction vessel so that a liquid level in the reaction vessel is between 2 inches and 16 inches.

6. The method of claim 5, wherein introducing ultra low sulfur diesel fuel into the reaction vessel comprises introducing ultra low sulfur diesel fuel into the reaction vessel so that the liquid level in the reaction vessel is between 4 inches and 14 inches.

7. The method of claim 6, wherein introducing ultra low sulfur diesel fuel into the reaction vessel comprises introducing ultra low sulfur diesel fuel into the reaction vessel so that the liquid level in the reaction vessel is between 6 inches and 12 inches.

8. The method of claim 5, wherein the inner height of the reaction vessel is 59.75 inches and the inner diameter of the reaction vessel is 27.5 inches.

9. The method of claim 1, wherein delivering a gas through the one or more spargers comprises operating a pump at a pump speed between 30% and 60% of a maximum pump output to pump gas through the spargers.

10. A system for converting an ultra low sulfur diesel fuel to a kerosene product, the system comprising:
a reaction vessel configured to house an ultra low sulfur diesel fuel;
one or more catalyst grids configured to be positioned above the ultra low sulfur diesel fuel within the reaction vessel; and
one or more spargers positioned below the one or more catalyst grids within the reaction vessel and configured to introduce gas into the ultra low sulfur diesel fuel within the reaction vessel so as to form aerosol droplets that pass through the one or more catalyst grids at a speed between 0.01 m/s and 0.7 m/s.

11. The system of claim 10, wherein the one or more spargers are configured to introduce gas within the ultra low sulfur diesel fuel so that the aerosol droplets pass through the one or more catalyst grids at a speed between 0.05 m/s and 0.65 m/s.

12. The system of claim 11, wherein the one or more spargers are configured to introduce gas within the ultra low sulfur diesel fuel so that the aerosol droplets pass through the one or more catalyst grids at a speed between 0.1 m/s and 0.6 m/s.

13. The system of claim 12, wherein the one or more spargers are configured to introduce gas within the ultra low sulfur diesel fuel so that the aerosol droplets pass through the one or more catalyst grids at a speed between 0.2 m/s and 0.5 m/s.

14. The system of claim 10, wherein the reaction vessel comprises a cylindrical reaction vessel having an inner height between 55 inches and 65 inches and an inner diameter between 22.5 inches and 32.5 inches.

15. The system of claim 14, wherein the reaction vessel is configured to house the ultra low sulfur diesel fuel at a liquid level between 2 inches and 16 inches.

16. The system of claim 15, wherein the reaction vessel is configured to house the ultra low sulfur diesel fuel at a liquid level between 4 inches and 14 inches.

17. The system of claim 16, wherein the reaction vessel is configured to house the ultra low sulfur diesel fuel at a liquid level between 6 inches and 12 inches.

18. The system of claim 14, wherein the inner height of the reaction vessel is 59.75 inches and the inner diameter of the reaction vessel is 27.5 inches.

19. The system of claim 10, further comprising a pump configured to deliver a gas through the one or more spargers.

20. The system of claim 10, further comprising a condenser configured to condense a product gas resulting from the passing of the aerosol droplets through the catalyst grids to form a kerosene product.
